(19) United States
(12) Patent Application Publication
(10) Pub. No.: US 2026/0155720 A1
(43) Pub. Date: Jun. 4, 2026

(54) VIBRATION MOTOR

(71) Applicant: AAC Microtech (Changzhou) Co., Ltd., Changzhou City (CN)

(72) Inventors: Xixi Zou, Changzhou (CN); Hongmei Yan, Changzhou (CN); Xia Zheng, Changzhou (CN)

(21) Appl. No.: 19/019,382

(22) Filed: Jan. 13, 2025

Related U.S. Application Data
(63) Continuation of application No. PCT/CN2024/136485, filed on Dec. 3, 2024.

(51) Int. Cl. H02K 33/02; H02K 33/18

(52) U.S. Cl. CPC H02K 33/02; H02K 33/18

(57) ABSTRACT

The present disclosure discloses a vibration motor including a stator, including: a housing and two driving units; an elastic member; and a vibrator suspended in the housing through the elastic member, including a magnet arranged between the two driving units and magnetized along the first direction; each of the two driving units includes an iron core fixed to the housing and extending along the first direction, and a winding wound around the iron core; the windings of the two driving units have same current direction; the magnet includes two end portions along a second direction perpendicular with the first direction, the elastic member is fixed to one of the two end portions; when inputting periodic current to the windings, periodic electromagnetic force is generated between the two driving units and the magnet to drive the vibrator to vibrate along the second direction.

### FIELD OF THE PRESENT DISCLOSURE

The present disclosure relates to vibrator technologies, especially relates to a vibration motor applied in portable mobile terminals.

### DESCRIPTION OF RELATED ART

With the development of the portable mobile terminal technologies, users have increasingly high requirements for the haptics feedback of portable mobile terminals. And a vibration motor in portable mobile terminals is the necessary component to achieve the haptics feedback.

In related art, the vibration motor having complex structure is not prone to assembly, and also occupies larger space in the portable mobile terminals which has adverse effect on miniaturization trend. Besides, it is hard to meet both low cost and high-performance requirement.

Therefore, it is necessary to provide an improved vibration motor to overcome the problems mentioned above.

### SUMMARY OF THE INVENTION

One object of the present disclosure is to provide a vibration motor with smaller size and easy to be assembled.

The vibration motor includes a stator, including: a housing having a receiving space; and two driving units mounted on the housing, arranged at an interval along a first direction; an elastic member; and a vibrator suspended in the receiving space and connected to the housing through the elastic member, including a magnet arranged between the two driving units and magnetized along the first direction; wherein each of the two driving units includes an iron core fixed to the housing and extending along the first direction, and a winding wound around the iron core; the windings of the two driving units have same current direction; the magnet includes two end portions along a second direction perpendicular with the first direction, the elastic member is fixed to one of the two end portions; when inputting periodic current to the windings, periodic electromagnetic force is generated between the two driving units and the magnet to drive the vibrator to vibrate along the second direction.

As an improvement, an amount of the elastic member is two; the vibrator further includes two pole cores separately mounted on the two end portions; each of the two pole cores is connected to the housing through a respective one of the two elastic members.

As an improvement, the two elastic members are separately located on two sides of the vibrator along the second direction; each of the two elastic members extends along a third direction and comprises two ends along the third direction fixed to the housing; the third direction is perpendicular with the first direction and the second direction.

As an improvement, a through hole is provided on each of the two elastic members; each of the two pole cores includes a main portion and a protrusion protruding from the main portion; the protrusion extends into the through hole of the corresponding one of the two elastic members.

As an improvement, an amount of the through hole provided on each of the two elastic members is two; the two through holes are arranged at an interval along the third direction; an amount of the protrusion on each of the two pole cores is two; the two protrusions are arranged at an interval along the third direction; each of the two protrusions extends into a respective one of the two through holes.

As an improvement, the magnet includes a first magnet portion and a second magnet portion magnetized along opposite direction; the first magnet portion and the second magnet portion are integrally molded.

As an improvement, the magnet further includes a nonmagnetic portion located between the first magnet portion and the second magnet portion.

As an improvement, the magnet includes a first magnet portion and a second magnet portion magnetized along opposite direction; the first magnet is glued to the second magnet.

As an improvement, the housing includes two first side walls opposite to each other along the first direction, and two second side walls opposite to each other along the third direction, the receiving space is jointly enclosed by the two first side walls and the two second side walls.

As an improvement, one of the two first side walls is integrally molded with adjacent one of the two second side walls.

As an improvement, the iron core includes a plurality of iron sheets overlapped with each other.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a vibration motor in accordance with an exemplary embodiment of the present disclosure.

FIG. 2 is an isometric view of the vibration motor in FIG. 1 without an elastic member.

FIG. 3 is a front view of the vibration motor in FIG. 1

FIG. 4 is a cross-sectional view of the vibration motor taken along line A-A in FIG. 3.

FIG. 5 is an exploded view the vibration motor in FIG. 1.

FIG. 6 is an isometric view of a stator of the vibration motor in FIG. 1.

FIG. 7 is an isometric view of a rotor of the vibration motor in FIG. 1.

FIG. 8 is schematic diagram of a magnet of the vibration motor in accordance with an exemplary embodiment of the present disclosure.

FIG. 9 is schematic diagram of a magnet of the vibration motor in accordance with another exemplary embodiment of the present disclosure.

FIG. 10 is schematic diagram of a magnet of the vibration motor in accordance with another exemplary embodiment of the present disclosure.

FIG. 11 is schematic diagram of a housing of the vibration motor in accordance with an exemplary embodiment of the present disclosure.

FIG. 12 is schematic diagram of a housing of the vibration motor in accordance with another exemplary embodiment of the present disclosure.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

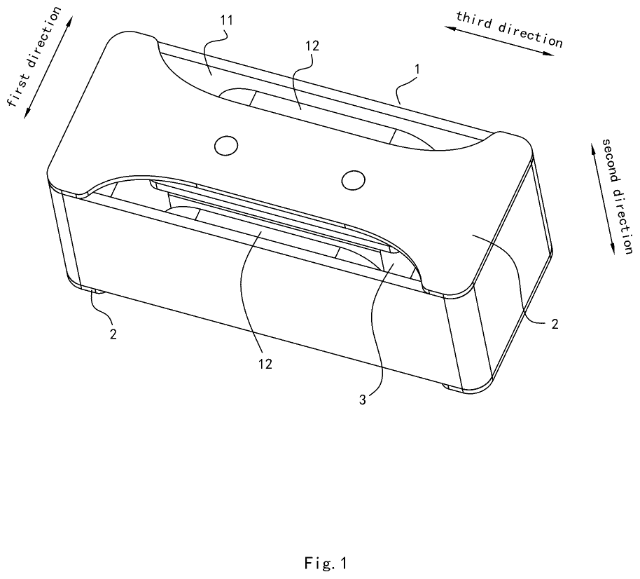

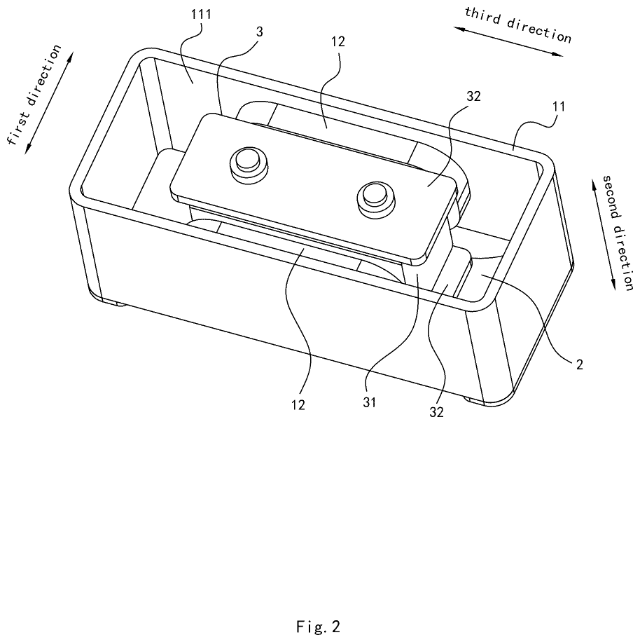

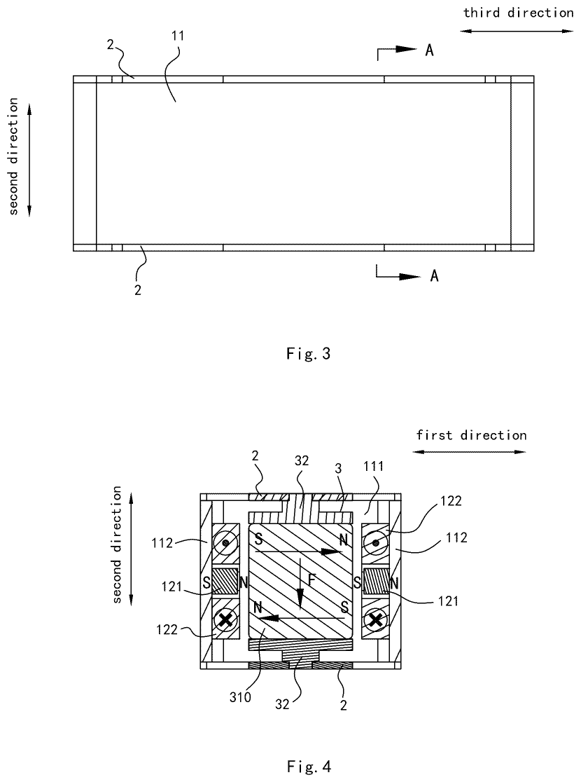

Please refer to FIGS. 1-5 together, a vibration motor 100 provided by an exemplary embodiment of the present disclosure includes a stator 1, an elastic member 2, and a vibrator 3.

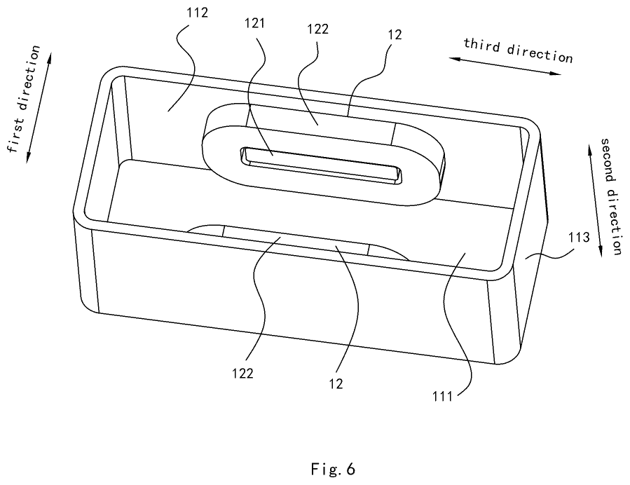

As shown in FIG. 6, the stator 1 includes a housing 11 having a receiving space 111, and two driving units 12 received in the receiving space 111. The two driving units 12 are mounted on the housing and arranged at an interval along a first direction.

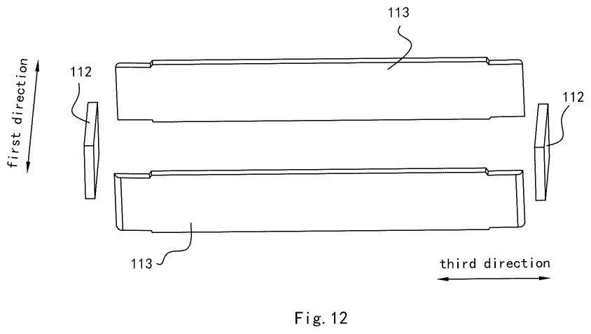

Specifically, the housing 11 includes two first side walls 112 opposite to each other along the first direction, and two second side walls 113 opposite to each other along a third direction perpendicular with the first direction. The receiving space 111 is jointly enclosed by the two first side walls 112 and the two second side walls 113. The two driving units 12 are separately mounted on the two first side walls 112. Furthermore, as shown in FIG. 11, one of the two first side walls 112 is integrally molded with adjacent one of the two second side walls 113. In one embodiment, as shown in FIG. 12, the two first side walls 112 and the two second side walls 113 is individual components which could be weld together. The housing 11 is made of magnetic conductive material.

Each of the two driving units 12 includes an iron core 121 fixed to the first side wall 112 and extending along the first direction, and a winding 122 wound around the iron core 121. The windings 122 of the two driving units 12 have same current direction. It should be understood that the winding 122 is a hollow structure having a thickness direction parallel to the first direction.

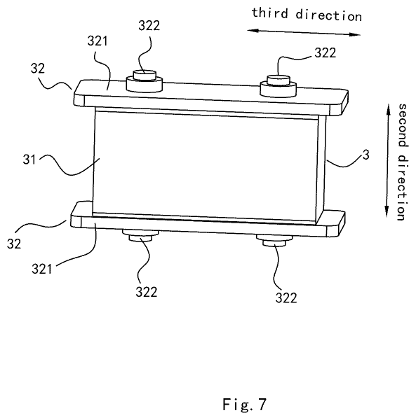

As shown in FIG. 7, the vibrator 3 is suspended in the receiving space 111 and connected to the housing 11 through the elastic member 2. The vibrator 3 includes a magnet 31 arranged between the two driving units 12 and magnetized along the first direction. It should be understood that the vibrator 3 is arranged at a distance from the two driving units 12. The magnet 31 is located opposite to the driving units 12 along the first direction.

To be specific, the magnet 31 includes two end portions 310 along a second direction perpendicular with the first direction. The elastic member 2 is fixed to one of the two end portion 310 to suspend the magnet 31 in the receiving space 111. When inputting periodic current to the windings 122, periodic electromagnetic force is generated between the two driving units 12 and the magnet 31 to drive the vibrator 3 to vibrate along a second direction.

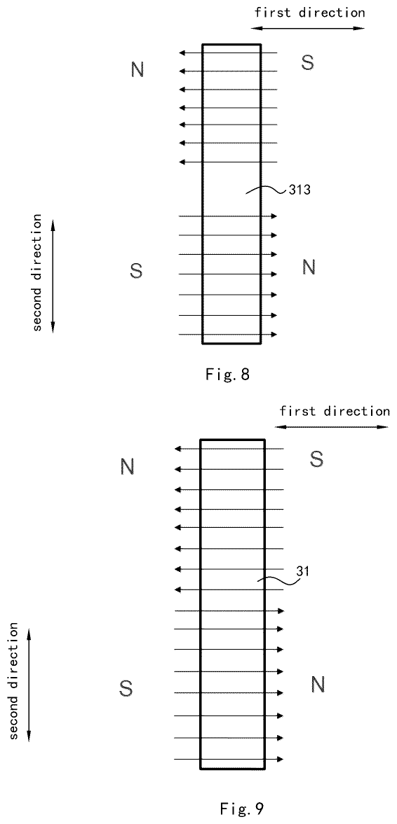

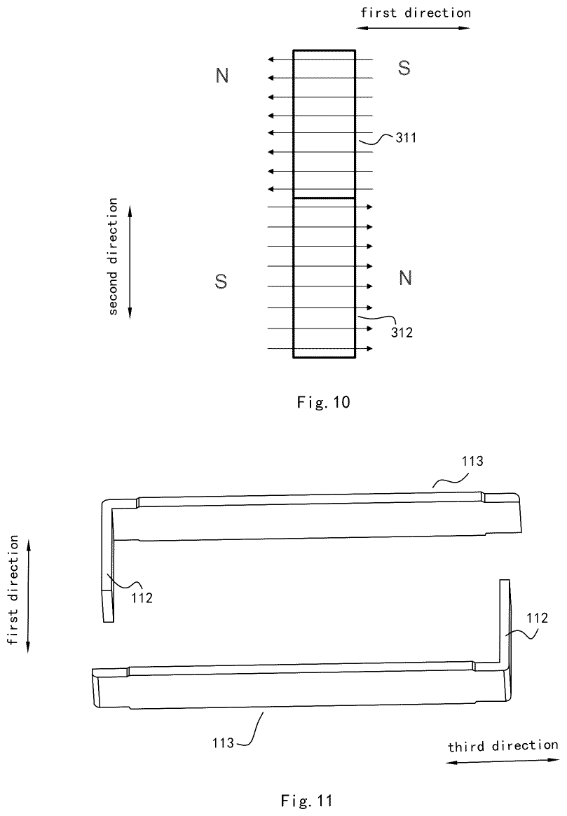

In one embodiment, as shown in FIG. 8, the magnet 31 includes a first magnet portion 311 and a second magnet portion 312 magnetized along opposite direction. The first magnet portion 311 and the second magnet portion 312 are integrally molded. Besides, as shown in FIG. 9, the magnet 31 further includes a nonmagnetic portion 313 located between the first magnet portion 311 and the second magnet portion 312. In another embodiment, as shown in FIG. 10, the first magnet portion 311 and the second magnet portion 312 are both individual magnet block. The first magnet portion 311 is glued to the second magnet portion 312.

Moreover, an amount of the elastic member 2 is two. The two elastic members 2 are arranged on two sides of the vibrator 3 along the second direction. The vibrator 3 further includes two pole cores 32 separately mounted on the two end portions 310, thus reducing magnetic leakage and improving magnetic field efficiency. Each of the two pole cores 32 is connected to the housing 11 through a respective one of the two elastic members 2.

To be specific, each of the two elastic members 2 extends along the third direction and includes two ends along the third direction separately fixed to the two second side walls 113. The third direction is perpendicular with the first direction and the second direction. In addition, the elastic member 2 is a plate spring. The pole core 32 is connected to a middle part of the elastic member 2.

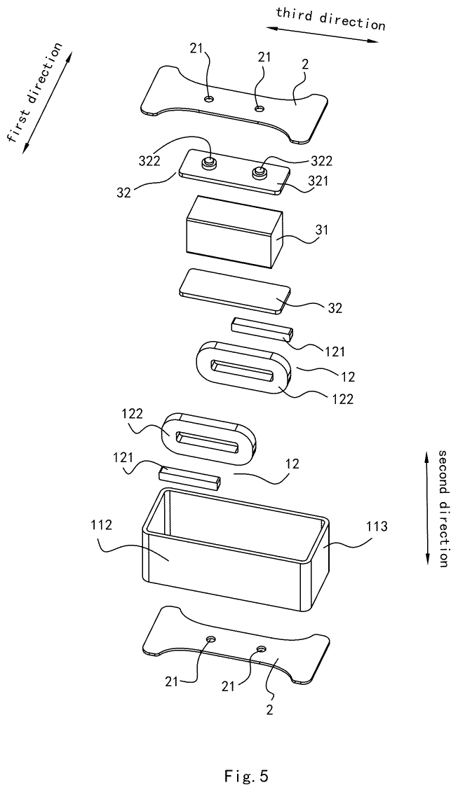

As shown in FIG. 5, a through hole 21 is provided on each of the two elastic members 2. Each of the two pole cores 32 includes a main portion 321 and a protrusion 322 protruding from the main portion 321. The protrusion 322 extends into the through hole 21 of the corresponding one of the two elastic members 2. In this manner, the elastic member 2 and the vibrator 3 could be easily assembled together. In one embodiment, the through holes 21 are located at a central position of the elastic member 2.

Furthermore, an amount of the through hole 21 provided on each of the two elastic members 2 is two. The two through holes 21 are arranged at an interval along the third direction. An amount of the protrusion 322 on each of the two pole cores 32 is two. The two protrusions 322 are arranged at an interval along the third direction. Each of the two protrusions 322 extends into a respective one of the two through holes 21, further improving the fixation stability between the vibrator 3 and the elastic member 2.

In addition, the housing 11 is a hollow structure including two openings 112. Two ends of the elastic member 2 are mounted on the two second side walls 113 respectively thus stretching over the opening 112. Thus, the vibrator 3 is sandwiched between the two elastic members 2.

In one embodiment, the iron core 121 includes a plurality of iron sheets overlapped with each other, thus reducing eddy current loss.

Compared with the related art, the vibration motor has simple structure prone to be assembled, and combines the virtues of smaller bulk and stronger haptics feedback.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor comprising:
a stator, including:
a housing having a receiving space; and
two driving units mounted on the housing, arranged at an interval along a first direction;
an elastic member; and
a vibrator suspended in the receiving space and connected to the housing through the elastic member, including a magnet arranged between the two driving units and magnetized along the first direction; wherein
each of the two driving units includes an iron core fixed to the housing and extending along the first direction, and a winding wound around the iron core; the windings of the two driving units have same current direction;
the magnet comprises two end portions along a second direction perpendicular with the first direction, the elastic member is fixed to one of the two end portions; when inputting periodic current to the windings, periodic electromagnetic force is generated between the two driving units and the magnet to drive the vibrator to vibrate along the second direction.

2. The vibration motor as described in claim 1, wherein an amount of the elastic member is two; the vibrator further comprises two pole cores separately mounted on the two end portions; each of the two pole cores is connected to the housing through a respective one of the two elastic members.

3. The vibration motor as described in claim 2, wherein the two elastic members are separately located on two sides of the vibrator along the second direction; each of the two elastic members extends along a third direction and comprises two ends along the third direction fixed to the housing; the third direction is perpendicular with the first direction and the second direction.

4. The vibration motor as described in claim 3, wherein a through hole is provided on each of the two elastic members; each of the two pole cores comprises a main portion and a protrusion protruding from the main portion; the protrusion extends into the through hole of the corresponding one of the two elastic members.

5. The vibration motor as described in claim 4, wherein an amount of the through hole provided on each of the two elastic members is two; the two through holes are arranged at an interval along the third direction; an amount of the protrusion on each of the two pole cores is two; the two protrusions are arranged at an interval along the third direction; each of the two protrusions extends into a respective one of the two through holes.

6. The vibration motor as described in claim 1, wherein the magnet comprises a first magnet portion and a second magnet portion magnetized along opposite direction; the first magnet portion and the second magnet portion are integrally molded.

7. The vibration motor as described in claim 6, wherein the magnet further comprises a nonmagnetic portion located between the first magnet portion and the second magnet portion.

8. The vibration motor as described in claim 1, wherein the magnet comprises a first magnet portion and a second magnet portion magnetized along opposite direction; the first magnet portion is glued to the second magnet portion.

9. The vibration motor as described in claim 1, wherein the housing comprises two first side walls opposite to each other along the first direction, and two second side walls opposite to each other along the third direction, the receiving space is jointly enclosed by the two first side walls and the two second side walls.

10. The vibration motor as described in claim 9, wherein one of the two first side walls is integrally molded with adjacent one of the two second side walls.

11. The vibration motor as described in claim 1, wherein the iron core comprises a plurality of iron sheets overlapped with each other.
